(19) United States
(12) Patent Application Publication
(10) Pub. No.: US 2014/0093343 A1
(43) Pub. Date: Apr. 3, 2014

(54) Vehicular loading apparatus

(71) Applicant: James P. Donohue, Fairborn, OH (US)

(72) Inventor: James P. Donohue, Fairborn, OH (US)

(21) Appl. No.: 13/573,886

(22) Filed: Oct. 12, 2012

Related U.S. Application Data
(63) Continuation-in-part of application No. 12/653,610, filed on Dec. 16, 2009, now abandoned.

(51) Int. Cl. B60P 1/43

(52) U.S. Cl. CPC B60P 1/43
USPC 414/538

(57) ABSTRACT

A vehicle loading apparatus with stanchions mounted on the first forward corners of a truck bed by means of saddles straddling the front rail of the truck bed and force stops in the forward stake wells of the truck bed. The (adjustably positioned) force stops are each mounted on a respective torque arm which is attached to a respective saddle. Resilient padding protects painted truck bed surfaces in contact with the stanchions as well as reduces noise and vibration. The vehicle loading apparatus can be installed as is needed, and removed as desired, simply, without tools, and without alterations to most common pickup truck beds.

This Continuation-in-Part Application is related to and claims priority to U.S. patent application Ser. No. 12/653,610 (Donohue), entitled “Vehicular Loading Apparatus” filed on Dec. 16, 2009.

### FIELD OF USE

This invention relates to a winching apparatus for, but not restricted to, the loading items into a vehicle, such as pickup trucks.

### BACKGROUND OF THE INVENTION

Putting heavy objects into the beds of pickup trucks is currently a difficult and, often, hazardous operation, especially for a single operator.

Prior approaches to vehicular loading apparatuses are large, bulky and difficult to operate by a single operator.
U.S. Pat. No. 7,070,059 (Flowers et al.) is an improved hoist for repositioning a load relative to a vehicle compartment such as a trunk of a vehicle. The hoist comprises a base for location on a generally horizontal lower surface of the vehicle compartment. A horizontal telescoping shaft has two distal ends extending from opposed sides of the base for engaging with opposed generally vertical surfaces of the vehicle compartment. A vertical telescoping shaft having a distal end extends vertically from the improved hoist for engaging with an upper generally horizontal surface of the vehicle compartment. A vertical expander acts between the base surface and the distal end of the vertical telescoping shaft for applying a vertical engaging force between the lower and upper generally horizontal surfaces of the vehicle compartment for vertically stabilizing the base within the vehicle compartment.
U.S. Pat. No. 5,242,257 (Avakian) is a gravity-assisted lifting device which permits a load such as a folded wheelchair to be easily transferred between the cargo storage compartment of an unaltered passenger vehicle and the ground. The lifting device includes a pivotal frame, which raises and lowers the load between generally vertical and generally horizontal orientations, and a slide subassembly, which permits the load to be moved into or out of the storage compartment when in the horizontal orientation.
U.S. Pat. No. 4,391,379 (Paffrath) is a lifting device adapted to be mounted within an automobile trunk having a rigid boom mounted for free pivotal movement about both vertical and horizontal axes. The lifting device includes a motor-driven lift mounted at the distal end of the boom. A counterbalance member is employed to counterbalance the gravitational force biasing the boom in downward movement about its horizontal axis so that the boom may be easily pivoted upwardly or downwardly by a handicapped person. A prop assembly may be manually moved into position to positively maintain the boom in an elevated lifting position.

What is needed is a system that enables one operator to load and unload cargo into a truck without the risk of bodily injury to the operator while also not damaging the cargo.

What is also needed is a system that is compatible with different makes and models of trucks, that is universal, and can be readily installed and removed from any of said makes and models of trucks.

For a complete understanding of the vehicular loading apparatus system of the present invention, reference is made to the following summary of the invention detailed description and accompanying drawings in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention.

### SUMMARY OF THE INVENTION

The present invention in the preferred embodiment is a vehicle loading apparatus comprising a first stanchion mounted on the first forward corners of a truck bed each by means of a saddle mounted over a front rail of the truck bed. Each saddle comprises a torque arm and a force stop, said force stop attached to said torque arm which is attached to said saddle. The force stops are inserted into the first forward stake wells of the truck bed. The force stop position is universally selectable to accommodate differing stake pocket positions of different truck makes, models, and sizes.

A winch is mounted on a first saddle wherein a cable attached to the winch is run through a pulley and hook combination and connected to a second stanchion which serves as a dead man post.

With the two stanchions located in the forward corners, at a distance from a load to be loaded into the truck bed, a reduced angle formed by the cable results in less side loads being transmitted to the truck bed of the vehicle which results in lower tension in the cable and reduced loading on both the winch and the truck bed.

Resilient padding is used between the contact areas of the saddles and the force stops with the truck bed to preclude damage to the truck bed's painted surfaces, to eliminate slippage, and to reduce noise and vibration.

The vehicle loading apparatus is installable and removable, before and after using, without the need for tools and without altering the truck bed.

For a complete understanding of the vehicular loading apparatus system of the present invention, reference is made to the following summary of the invention detailed description and accompanying drawings in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention.

### BRIEF DESCRIPTION OF THE DRAWINGS

FIG. 1 depicts an application of the first preferred embodiment of the vehicle loading apparatus of the present invention.

FIG. 2 depicts a first preferred embodiment of a winch and a right side stanchion assembly of the vehicle loading apparatus of FIG. 1.

FIG. 3 depicts details a first preferred embodiment of the right side stanchion assembly of the vehicle loading apparatus of FIG. 1.

FIG. 4 depicts details of a first preferred embodiment of a left side stanchion assembly of the vehicle loading apparatus of FIG. 1.

FIG. 5 depicts details of the left side stanchion assembly of the vehicle loading apparatus of FIG. 1.

FIG. 6 depicts a truck bed partial, front sectional view with focus on the front (right and left) stake pocket positioning and variance generalized range for a conventional pickup truck for use with a second preferred embodiment of the vehicle loading apparatus of the present invention.

FIG. 7 depicts the left stanchion and the universal adjustability capabilities of the left extension arm, which enable the system to accommodate the range of positioning of the push foot for use with the truck bed partial, front sectional view depicted in FIG. 6.

FIG. 8 depicts the right stanchion and the universal adjustability capabilities of the right extension arm, which enable the system to accommodate the range of positioning of the push foot for use with the truck bed partial, front sectional view depicted in FIG. 6.

### DETAILED DESCRIPTION OF THE PREFERRED EMBODIMENTS

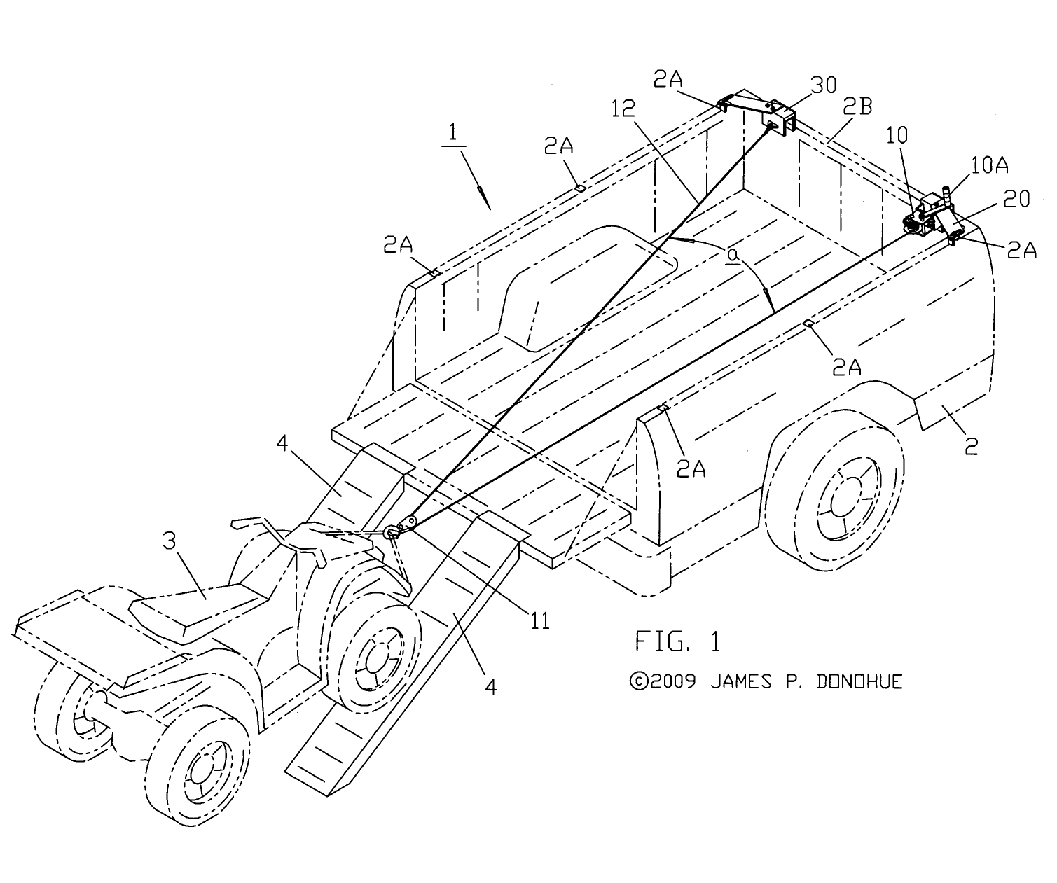

Referring now to FIG. 1, the preferred embodiment of the present invention, a vehicle loading apparatus [1] comprises at least one tailgate ramp [4], a winch [10] shown with a manual crank [10A], a pulley/hook [11], a cable [12], a right side stanchion [20], and a left side stanchion [30].

The cable [12] is attached to the winch [10]. The cable [12] is strung through the pulley/hook [11] to the left side stanchion [30], which serves as an anchor, or dead man post.

While the drawing nomenclature refers to a right side stanchion [20] with the winch [10] on the right side stanchion [20], and a left side stanchion [30] serving as an anchor, or dead man post, as obvious to anyone skilled in the art, with minor detail changes in said apparatus [1], the winch [10] could be located on either side of the truck body [2]. However, in the event of an operator operating the winch [10], with a truck with the truck bed [2] on the shoulder of a road or highway, the operator would usually be standing on the right side of the truck bed [2], for safety reasons, with the truck bed [2] between the truck bed [2] and, in the United States, away from traffic, assuming a truck with the truck bed [2] is pointed in the direction of traffic flow. This is a much safer position for an operator than being on the traffic side of the truck bed [2], or needing to be in the truck bed [2]. In the event of a mishap, such as, but not restricted to, a rear end collision from another vehicle with an inattentive, on a cell phone, or even drunk, driver, or a cable snapping, an operator's chances of surviving, even escaping injury, seem higher.

The pulley/hook [11] attaches to a load [3], such as, but not restricted to, an ATV, also known as an all-terrain vehicle. While the load [3] is shown as a four wheel ATV, centered on two ramps [4], it could as well be a three wheel ATV on three ramps [4], a lawn or garden vehicle, or a carcass, such as, but not restricted to, a deer carcass, being pulled up one or more ramps [4], as required, or on a dolly riding up at least one ramp [4]. For purposes of enablement, all sorts of ramps are available from a variety of sources, such as, but not restricted to user fabricated loading ramps from plywood and 2×4 supports to get wider load ramps for miscellaneous loads, or even 2×12 wooden planks.

Having the stanchions [20] and [30] at the forward corners of the truck bed [2], means an angle a formed by the cable [12], when the cable [12] is strung from the winch [10] to the left side stanchion [30], through the pulley/hook [11], is held to a minimum angle as compared to the stanchions [20] and [30] located at other stake wells [2A] closer to the load [3]. This is important because by minimizing angle a, side forces on the truck bed [2] are minimized. Also, the forward corners of the truck bed [2] are relatively structurally rigid as compared to other possible locations, such as, but not restricted to, other stake wells locations. Also, minimizing side loading forces, with a minimal angle a, reduces tension in the cable [12], which means less effort to turn the handle [10A] as well as less tension, loads on the winch [10], the stanchions [20] and [30], and the truck bed [2].

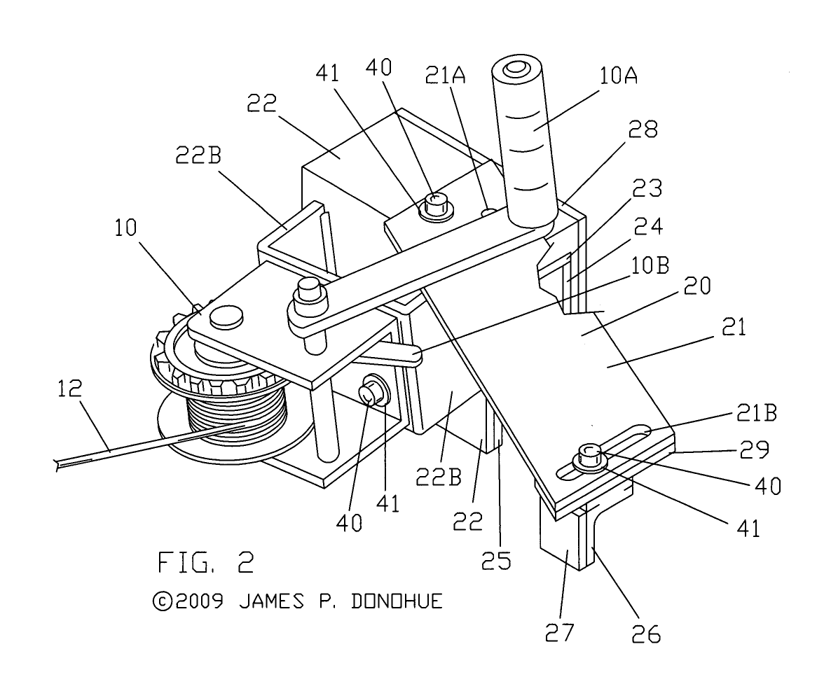

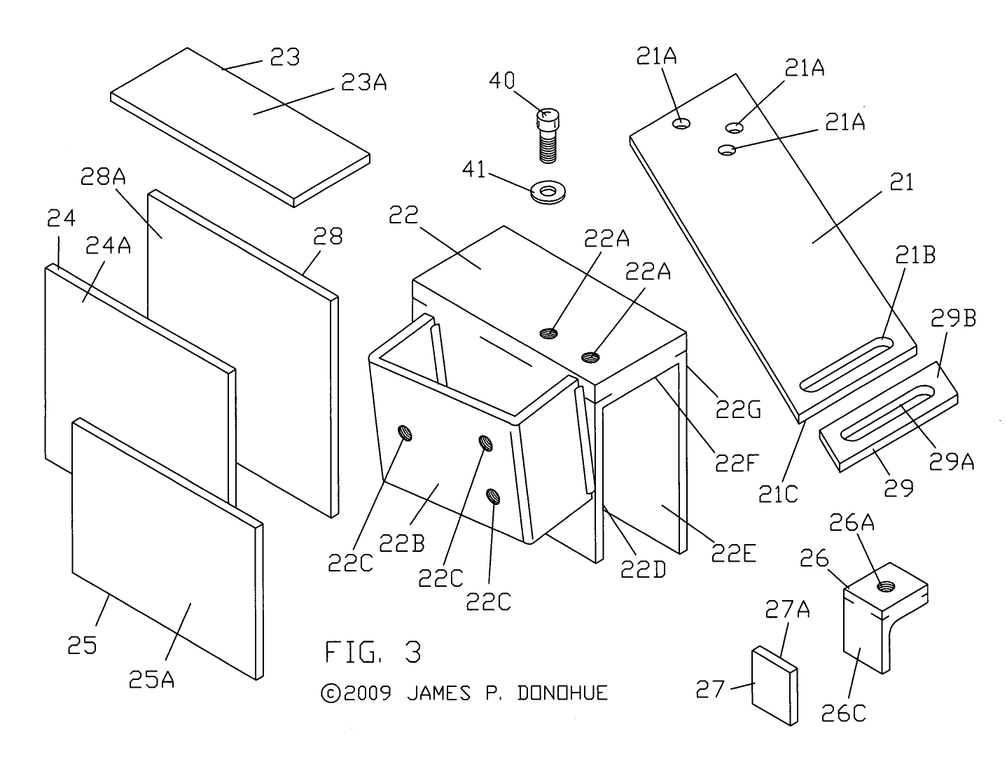

Referring to FIGS. 2 and 3, the right side stanchion [20] comprises a right side extension [21] comprising saddle mounting apertures [21A], which enables selective positioning of the right side extension, a force stop adjustment slot [21B], and a resilient pad mounting surface [21C]; a winch saddle [22] comprising mounting threaded apertures [22A], and resilient pad mounting surfaces [22D], [22E], [22F], and [22G]; winch mounting bracket [22B] comprising winch mounting holes [22C]; resilient pads [23], [24], [25], [27], [28], and [29] with respective adhesive surfaces [23A], [24A], [25A], [27A], [28A], and [29B]; and a force stop [26] comprising a threaded aperture [26A] and with a mounting surface [26C]. The resilient pad [29] further comprises an adjustment slot [29A]. The saddle [22] simply slips over a front rail [2B] of the truck bed [2] and rests on the front rail [2B], no tools required to install and remove the stanchions [20] and [30] from the forward rail [2B] and forward left and right stake wells [2A].

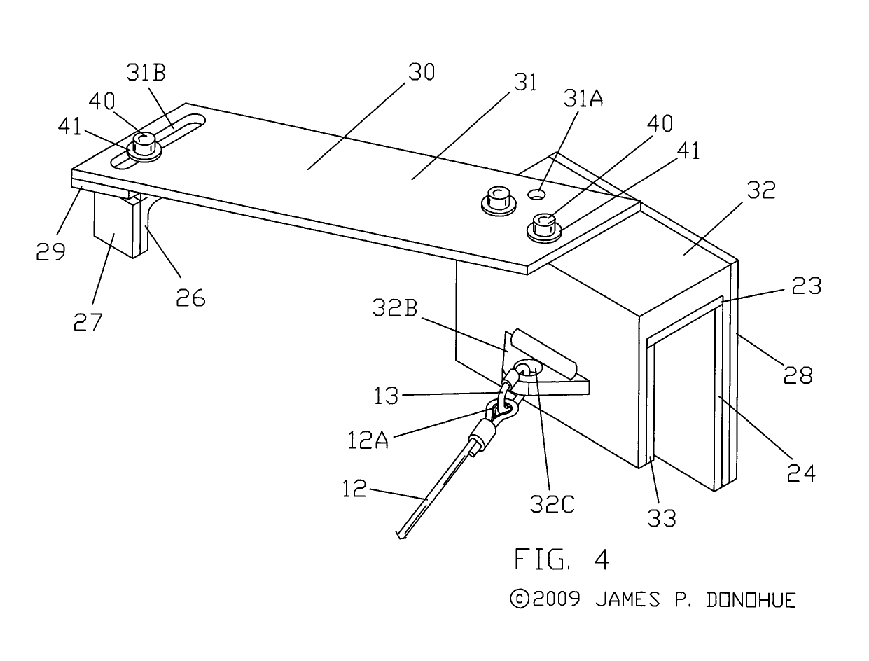

The resilient pads [23], [24], [25], [27], and [28] above serve as padding minimizing rattling, vibrations, and noise; enabling the saddles [22] and [32] (also see FIG. 4) and the force stops [26] to grip the truck bed [2] when under load, reducing a tendency of the saddles [22] and [32] and the force stops [26] to shift or be repositioned; and precluding scratching, marring, or damaging the truck bed [2] caused by handling during installation or removal of the stanchions [20] and [30] and the force stops [26].

The resilient pad [29] serves as a gasket and also for protection of adjacent stake well [2A] surfaces [20]. The winch [10] with the winch crank [10A] and the cable [12] is shown attached to winch mounting bracket [22B] which is shown affixed to the winch saddle [22].

Only one each of bolt [40] with washer [41] is shown as a means of attachment of various detail parts to avoid clutter. Threaded apertures are also shown as receptacles for various bolts [40] and washers [41]. As obvious to anyone skilled in the art, a variety of bolts, washers, nuts (not shown), and threaded and unthreaded apertures can be used as opposed to bolts and threaded apertures. The reason for illustrating a bolt and threaded apertures was to simplify the illustrations by eliminating unnecessary clutter.

The resilient pad [29], attaches to the pad mounting surface [21C] of the right side extension [21] by means of the adhesive surface [29B].

The right side extension [21] attaches to the winch saddle [22] by means of bolts [40] and washers [41].

Resilient pads [23], [24], [25], [27] and [28], with respective adhesive surfaces [23A], [24A], [25A], [27A], and [28A] mount on the respective surfaces [22F], [22E], [22D], [27A], [22C], and [22G] on the winch saddle [22].

The force stop [26] bolts to the right side extension [21], by means of the bolt [40] and washer [41], through the slots [21B] and [29A] respectively of said extension [21] and the resilient pad [29], said resilient pad [29] sandwiched in between said extension [21] and said force stop [26] (utilizing apertures [21a] and slots [21b], the force stop can be adjustably positioned to accommodate most truck makes, models and sizes).

The slots [21B] and [29A] permits adjustment of the position of the force stop [26] in order to permit insertion of the force stop [26] bolted to the right side extension [21] into the forward right side stake well [2A] of the truck bed [2], providing universal adjustability and usage.

The winch saddle [22] is inserted over the front rail [2B] of the truck bed [2] (refer also to FIG. 1) and force stop [26] is inserted into the forward right side stake well [2A] of the truck bed [2], providing a stable right side stanchion [20] resisting the tension force from the cable [12] when the cable [12] is pulling a load.

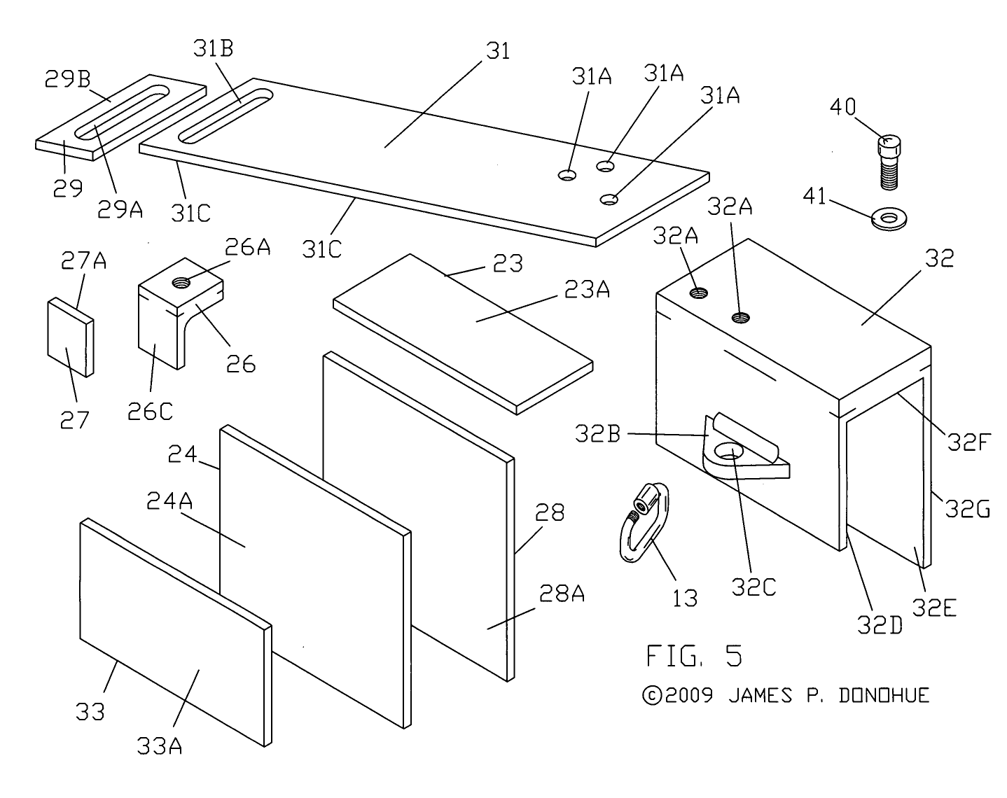

Referring now to FIGS. 4 and 5, the left side stanchion [30] comprises a left side extension [31] comprising left side saddle mounting apertures [31A], (which allows selective—swing arm—positioning of the left side extension), a left side force stop adjustment slot 31B, and a left side resilient pad mounting surface [31C]; a left side stanchion saddle [32] comprising left side stanchion apertures [32A], a tab [32B] comprising a tab aperture [32C], left side stanchion saddle resilient mounting surfaces [32D], [32E], [32F], and [32G]; a ring [13] which serves to connect an eye [12A] of the cable [12] to the tab [32B]; and the pads [23], [24], [27], [28], [29], and [33], the pad [29] comprising the adjustment slot [29A], with the respective adhesive surfaces [23A], [24A], [27A], [28A], [29B,] and [33A]; and the force stop [26] comprising the force stop threaded attachment aperture [26A] and the mounting surface [26C].

The tab [32B] comprising the tab aperture [32C] serves as an attachment tab for attachment of the cable [12] by means of the ring [13].

Said extensions [21] and [31] (having selective positioning capability as previously described) serve as torque arms between the force stops [26] and the respective said saddles [22] and [32], transmitting torque from forces on the force stops [26] to the saddles [22] and [32], which straddle the front rail [2B].

The resilient pad [29] attaches to the pad mounting surface [31C] of extension [31], in position with the adjustment slot [29A] of the resilient pad [29] aligned with the force stop adjustment slot [31B], by means of the adhesive surface [29B].

The left side extension [31] attaches to the left side stanchion saddle [32] by means of bolts [40] and washers [41]. Again, only one bolt [40] and one washer [41] shown to preclude a cluttered drawing.

Resilient pads [23], [24], [28], and [33] with respective adhesive surfaces [23A], [24A], [28A], and [33A] mount on the respective surfaces [32F], [32E], [32G], and [32D], of the left side stanchion saddle [32]. Resilient pad [27] with the adhesive surface [27A] mounts on the mounting surface [26C] of the force stop [26].

Said saddles [22] and [32] fit over the front rail [2B] (also see FIG. 1) of the truck bed [2] with the force stops [26] inserted in the stake wells [2A] of the truck bed [2]. The combination of said saddles [22] and [32] over the front rail [2B] and the force stops [26] inserted in the stake wells [2A], with each force stop [26] structurally attached to the respective extensions [21] and [31], with each of the extensions structurally attached to respective saddles [22] and [32] provides each of the stanchions [20] and [30] structural rigidity as required for the intended purpose of the vehicle loading apparatus 1.

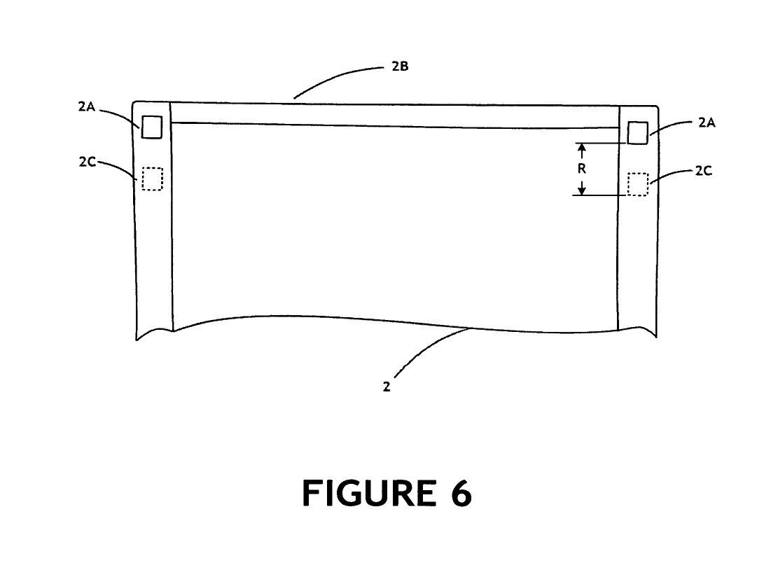

FIG. 6 depicts a truck bed [2] partial front section, with focus on the right and left front stake pocket [2A] positioning and variance generalized range [2C] for most pickup trucks and the truck bed front rail section [2B]. This stake generalized range [2C] must be accommodated for the vehicle loading apparatus of the present invention.

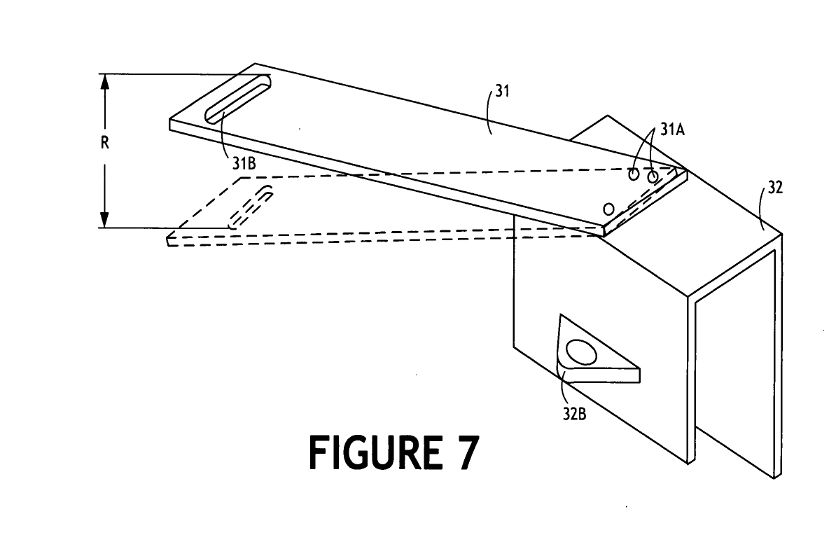

FIG. 7 depicts the left stanchion and the universal adjustability capabilities of the left extension arm, which enable the system to accommodate the range of positioning of the push foot [26]. R is the range of positioning the push foot into work with truck deck construction variations.

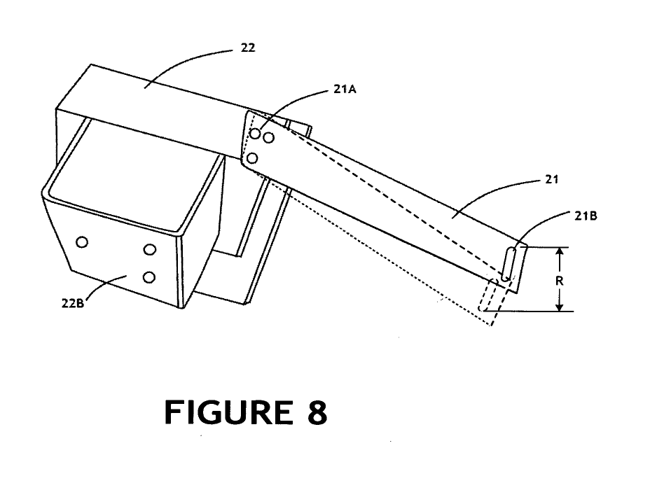

FIG. 8 depicts the right stanchion and the universal adjustability capabilities of the right extension arm, which enable the system to accommodate the range of the push foot [26]. R is the range of positioning the push foot into work with truck deck construction variations.

The force stops [26] serve at least two functions:
1. The force stops [26] are forced against their respective stake wells [2A] when there is a load on the cable [12], absorbing some of the force from the cable [12], relieving some of the force on the front rail [2B] of the truck bed [2] from the saddles [22] and [32]. This load distribution enables the vehicle loading apparatus [1] to withstand significant pulling forces without over stressing the truck body structure.
2. The force stops [26] serve as lateral anchors to the saddles, [22], [32], holding the saddles [22] and [32] in position on the front rail [2B] of the truck bed [2], as the cable [12] is loaded, especially in wet weather. The pads [23], [24], and [25] adhered to the saddle [22] and pads [23], [24] and [33] adhered to the saddle [32] assist in anchoring the respective saddles [22] and [32] in position.

The vehicle loading apparatus [1] has the advantage of being both installable and removable without any modifications or alterations to the truck bed [2]. After initial setup, positioning of the force stops utilizing the extension apertures [21A] and [31A] and the force stop positioning slots [21B] and [31B].

In the preferred embodiment of the present invention, the material of the pads is, but not restricted to, rubber, natural or synthetic, such as, but not restricted to BUNA-N, BUNA-S, compounds with EPDM or EPT, or cross-linked plastics suitable for the purpose. For purposes of enablement, a material thickness of 0.060 seems to work well. While padding could be applied by other means than adhesive, such as, but not restricted to painting or dipping, adhesive attachment seems to be working well.

For purposes of enablement, in the preferred embodiment of the present invention, steel seems to be working well. While aluminum could serve the purpose, and possibly save some weight, the cost could be a barrier to successful commercialization. As a generality, the invention is not restricted to steel, other materials, such as, but not restricted to aluminum as well as suitable composite materials could work as well.

For purposes of enablement, the ring [13] is common to the trade and is often referred to as a Quick Link or a D-ring.

For purposes of enablement, in the preferred embodiment of the present invention, applicant is presently using the Dutton-Lainson DL600A, DLB800A, or DLOB805A winches, which are available in sporting goods stores, watercraft dealerships, and farmer supplies stores. These winches [10] work on a sprocket-ratchet principle, as the load [3] is pulled into the truck bed [2], a spring operated ratchet locks the load [3] with each incremental forward rotation of the user operated manual crank 10A. The operation of pulling the load [3] into the truck bed [2] can be halted at any point in time of the operation and the manual crank [10A] released, i.e. let go, with the ratchet locking the load in position until the manual crank [10A] is again rotated in a forward direction, continuing the operation of pulling the load [3] into the truck bed [2].

There is a ratchet release lever on the above winches [10], which allows the ratchet operation to be released and allows the load to be lowered down the at least one ramp [4] in a reverse direction unhindered by the ratchet locking operation. The operation of pulling the load [3] into the truck bed [2] is completely under the control of the user operated manual crank [10A]. The ratchet can be reengaged at any time to lock the load [3] in place.

Each of the above mentioned winch [10] models have various advantages and disadvantages. For example, the DL600A and the DLB805A models of the winch [10] have a “free wheel” feature which allows the cable [12] to be freely pulled from the winch [10] with the manual crank freely rotating. However the DLB800A model requires an operator to physically rotate the manual crank [10A] in a reverse direction against an integral brake system (not shown) until the desired length of cable [12] has been unwound from the DLB800A model winch [10]. During operation it can be seen in FIG. 1 that as the load [3], in this case a wheeled vehicle, moves up the ramp [4], the hook/pulley [11] allows both sides of the cable [12] to stay the same length, and this arrangement helps the load [3] stay centered within the truck bed [2] as the load [3] will experience an equal pulling force from each of the corner stanchions [20].

Although the description above contains many specificities, these should not be construed as limiting the scope of the invention but as merely providing illustrations of some of the presently preferred embodiments of this invention.

As opposed to using a manually operated winch [10], one could incorporate other types of winches, such as electric or even hydraulic.

As another example, the tab [32B] with the tab aperture [32C] is an example of a point of attachment for the cable [12]. As obvious to anyone skilled in the art, that is not the only way to fabricate a point of attachment to secure a cable [12].

Also, potential uses of the vehicle loading apparatus [1] are limited only by the imagination of operators of said apparatus [1]. For example, it might be used to winch other loads, such as pulling tree stumps, or moving loads on the ground, where there the end result of putting the load in the bed of the truck is not intended. The apparatus [1], for example, can be used in emergencies such as earthquakes or hurricanes, removing debris which may have fallen and covered people.

Also, while the most popular usage is envisioned as in conjunction with pickup trucks, it is not intended to limit the preferred embodiment of the present invention to only pickup trucks.

Throughout this Application there are various patents are referenced by number and inventor. The disclosures of these patents are hereby incorporated by reference into this specification in their entireties in order to more fully describe the state-of-the-art.

It is evident that many alternatives, modifications, and variations of the vehicular loading apparatus of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

### PARTS LIST

1. Vehicle loading apparatus.
2. Partial truck bed section.
2A. Stake pocket.
2B. Truck bed front rail section.
2C. Stake pocket alternate position.
4. Tailgate ramp.
10. Winch.
10A. Manual winch crank.
11. Pulley/hook.
12. Cable.
20. Right side stanchion.
21. Right side extension.
21A. Saddle mounting apertures.
21B. Force stop adjustment slot.
21C. Resilient pad mounting surface.
22. Winch saddle.
22A. Threaded mounting apertures.
22D, E, F, G. Resilient pad mounting surfaces.
23, 24, 27, 28, 29. Resilient pads.
26. Force stop.
26A. Threaded aperture.
26C. Mounting surface.
30. Right side stanchion.
31. Extension.
31A. Left saddle mounting apertures.
31B. Left saddle adjustment slot.
31C. Left saddle resilient pad mounting surface.
32. Saddle.
32A. Left stanchion apertures.
32B. Tab.
32C. Tab aperture.
32D, E, F, G. Left side stanchion resilient pad mounting surfaces.
33. Pad.
40. Bolt.
41. Washer.

I claim:

1. A vehicle loading apparatus comprising:
a winch,
a cable,
a first stanchion,
a second stanchion spaced from said first stanchion, and
a pulley wherein said stanchions each comprise a saddle, a torque arm, and a force stop;
wherein said force stop is attached to said torque arm which is attached to said saddle;
wherein said saddle can be placed over a front rail of a truck bed, straddling said front rail;
wherein said force stop is adjustably positioned for insertion into a stake well of said truck bed;
wherein said winch is mounted on said first stanchion;
wherein a first end of said cable is secured to said saddle of said second stanchion;
wherein a second end of said cable is attached to said winch;
wherein said cable is strung through said pulley;
wherein said pulley is attachable to a load to be loaded into said truck bed; and
wherein said winch operates to pull in said cable, which pulls said load towards said truck bed.

2. The vehicle loading apparatus of claim 1, wherein rubber padding protects said truck bed at points of contact between said vehicle loading apparatus and said truck bed front rail and said truck bed stake wells.

3. The vehicle loading apparatus of claim 1, further comprising at least one loading ramp.

4. The vehicle loading apparatus of claim 1, wherein said first stanchion is located adjacent a first corner of said truck bed on said bed rail and said second stanchion is located adjacent a second corner of said truck bed on said bed rail, said first corner being opposite of said second corner.

5. The vehicle loading apparatus of claim 1, wherein first and second ends of said cable pull with equal force on said first and second stanchions to transmit equal forces on each of first and second truck bed corners.

6. A winch loading apparatus comprising:
a winch,
a cable,
a first stanchion,
a second stanchion, and
a pulley,
wherein said first and second stanchions each comprise a saddle, a torque arm, and a force stop;
wherein said force stop is attached to said torque arm which is attached to said saddle;
wherein said saddle is placed over a front rail of a truck bed, straddling said front rail and said force stop is universally adjustably positionable and insertable into a stake well of said truck bed;
wherein said stake well is spaced from said front rail across a corner of said truck bed;
wherein said winch is mounted on said first stanchion and a first end of said cable is secured to said saddle of said second stanchion;
wherein a second end of said cable is attached to said winch;
wherein said cable is strung through said pulley which is attached to a load to be loaded into said truck bed; and
wherein, as said winch pulls in said cable with a force, said load moves towards said front rail with said force divided into two equal partial forces, each partial force directed toward one of said stanchions.

7. The winch loading apparatus of claim 7, wherein said first stanchion is located adjacent a first corner of said truck bed on said bed rail and said second stanchion is adjacent a second corner of said bed rail, said first corner being opposite of said second corner.

8. The winch loading apparatus of claim 7, wherein each saddle includes padding to protect said truck bed at points of contact between said saddle and said truck bed rail.

9. The winch loading apparatus of claim 7, further comprising a tailgate ramp, enabling said cable to pull a load up said ramp onto said truck bed.

10. A loading apparatus comprising:
a winch,
a cable,
a first stanchion,
a second stanchion, and
a pulley,
wherein said first and second stanchions each placed over a front rail of a vehicle bed;
wherein said winch is mounted on said first stanchion on a first corner of said bed and a first end of said cable is secured to said second stanchion, said second stanchion is mounted adjacent a second vehicle bed corner spaced from said first corner by essentially said length of said front rail;
wherein a second end of said cable is attached to said winch;
wherein a pulley attaches a load to said cable; and
wherein, as said winch pulls in said cable with a force, said load moves towards said front rail with said force divided into essentially two equal forces, each partial force directed toward one of said stanchions.

11. The loading apparatus of claim 10, wherein each of said stanchions comprise a force stop adjustably positionable and insertable in a stake well of said vehicle bed, said force stop connected to said stanchion by a torque arm.

12. The loading apparatus of claim 10, wherein each stanchion comprises a saddle resting on said front rail, wherein each saddle comprises padding to protect said vehicle bed at points of contact between said saddle and said vehicle bed.

13. The loading apparatus of claim 11, wherein said vehicle bed comprises a tailgate ramp and said cable pulls a load up said ramp onto said vehicle bed and wherein said vehicle is a truck.

14. The loading apparatus of claim 13, wherein said placement of said force stops with respect to said pulling saddles structure is universally selectable by utilizing said selection positioning of said torque arms attachment apertures, and said force stop adjustment slots.
